(19) United States
(12) Patent Application Publication
(10) Pub. No.: US 2011/0238682 A1
(43) Pub. Date: Sep. 29, 2011

(54) DOCUMENT MANAGEMENT SYSTEM AND METHOD

(75) Inventor: Yousuke Ootaki, Yokohama-shi (JP)

(73) Assignee: CANON KABUSHIKI KAISHA, Tokyo (JP)

(21) Appl. No.: 13/050,343

(22) Filed: Mar. 17, 2011

(30) Foreign Application Priority Data
Mar. 25, 2010 (JP) 2010-070026

(51) Int. Cl. G06F 17/30

(52) U.S. Cl. 707/758; 707/E17.008; 707/E17.108

(57) ABSTRACT

When a document searcher transmits E-mail including a search condition to a document management system and searches for a document, a document search result can be obtained irrespective of an access right which the document searcher has. In order to solve this problem, the document management system searches a database for the document corresponding to document search information received from the document searcher, and transmits a message requesting a permission for the document searcher to obtain the document to a creator of the searched document.

### BACKGROUND OF THE INVENTION

1. Field of the Invention

The present invention relates to a document management system, method, and program for searching for a document based on a search condition which is input by a document searcher and presenting a search result to the document searcher.

2. Description of the Related Art

A document management system has been disclosed in, for example, Japanese Patent Application Laid-Open No. 2003-58542. In Japanese Patent Application Laid-Open No. 2003-58542, a document searcher transmits E-mail including a search condition to the document management system, and the document management system returns E-mail including a document list constructed by a list of documents which satisfy the received search condition to the document searcher. Further, the document searcher selects a desired document on the received search result list, allows a document name of the selected document to be included in the E-mail, and transmits the E-mail again to the document management system, so that he can obtain the document.

### SUMMARY OF THE INVENTION

According to the foregoing technique, the document which is obtained as a document search result can be obtained irrespective of an access right. In dependence on document search information designated by the document searcher, an amount of search results becomes extremely large and it is difficult to specify the document to be obtained. Further, since the document name of a document creator is known by the document searcher, it is undesirable in terms of security.

To solve the above problem, the invention provides a document management system for communicating with a document storing device in which a plurality of documents are stored, the system comprising a reception unit that receives document search information designated by a document searcher; a search unit that searches the document storing device for one or more of the plurality of documents corresponding to the received document search information; a first transmission unit that transmits a message requesting a permission for the document searcher to obtain the searched one or more documents to a creator of the document; and a second transmission unit that transmits a message for obtaining the one or more documents to the document searcher if the creator of the document gives the permission.

According to the invention, whether or not the document searcher may obtain the information of the document which satisfies the search condition designated by the document searcher can be confirmed by the creator of the relevant document.

Further features of the present invention will become apparent from the following description of exemplary embodiments with reference to the attached drawings.

### BRIEF DESCRIPTION OF THE DRAWINGS

FIG. 1 is a conceptual diagram of a document search system according to the first embodiment of the invention.

FIG. 2 is a hardware constructional diagram of an application server of the document search system according to the first embodiment of the invention.

FIG. 3 is a software constructional diagram of the document search system according to the first embodiment of the invention.

FIG. 4 is an example of a search display screen 400 which is used when a document searcher 106 of the document search system according to the first embodiment of the invention searches for a document.

FIG. 5 is a flowchart illustrating a flow of a document search result notifying unit in the document search system according to the first embodiment of the invention.

FIG. 6 is a conceptual diagram of the flowchart illustrating the flow of the document search result notifying unit in the document search system according to the first embodiment of the invention.

FIG. 7 is a diagram illustrating details of a document storing unit 302, a document search index storing unit 303, a document attribute information storing unit 304, and a document creator information storing unit 305 stored in a database server 105 in the document search system according to the first embodiment of the invention.

FIG. 8 is a flowchart for a document obtainment accepting unit using the document search result notifying unit in the document search system according to the first embodiment of the invention.

FIG. 9 is an example of a UI of the document obtainment accepting unit using the document search result notifying unit in the document search system according to the first embodiment of the invention and E-mail which is transmitted to a document searcher 106.

FIG. 10 is an example in the case where a document creator 107 in the document search system according to the first embodiment of the invention sets a folder serving as a search target.

FIG. 11 is a software constructional diagram of a document search system according to the second embodiment of the invention.

FIG. 12 is a flowchart illustrating a flow of a document search result notifying unit using E-mail in the document search system according to the second embodiment of the invention.

FIG. 13 is a conceptual diagram of the flowchart illustrating the flow of the document search result notifying unit using the E-mail in the document search system according to the second embodiment of the invention.

FIG. 14 is a flowchart in the document search system according to the second embodiment of the invention.

FIG. 15 which is composed FIGS. 15A, 15B and 15C are flowcharts illustrating in detail steps 1403, 1406, and 1410 in FIG. 14.

FIG. 16 is an example in which a document management system 301 in the document search system according to the second embodiment of the invention extracts character strings written in a body of E-mail 1301 and reads out document search information.

FIGS. 17A and 17B are an example in which the document search information is written in the body of the E-mail 1301 in FIG. 13 and an example of a body of E-mail which is transmitted to the document searcher 106 in step 1412 in FIG. 14.

### DESCRIPTION OF THE EMBODIMENTS

Exemplary embodiments of the invention will be described hereinbelow with reference to the drawings.

Prior to describing the exemplary embodiments of the invention, first, terminologies will be defined. A “document management system” is a system that has a UI (and corresponding functions) through which the user uses a browser on a PC to access and operate an electronic document through a network. An “application server” is a server in which the document management system accessed from the outside through the Internet by means of http (Hyper Text Transfer Protocol) or https is activated as an application. A “database server” is a server that is connected to the application server, stores one or more documents registered by the user from the PC via the application server, and calls a stored document when the document is obtained from the PC via the application server. An “asynchronous server” is a server that is connected to the application server and the database server and asynchronously performs a creation of a thumbnail of the document, a creation of data for a whole sentence search, a creation of a user operation history report of the document management system. An “E-mail client” is a mail client application.

### First Embodiment

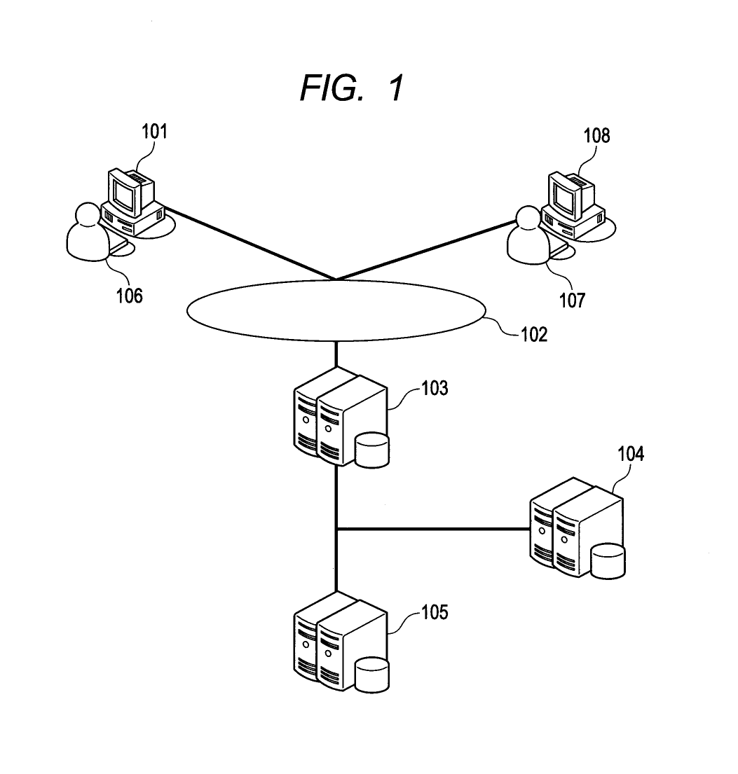

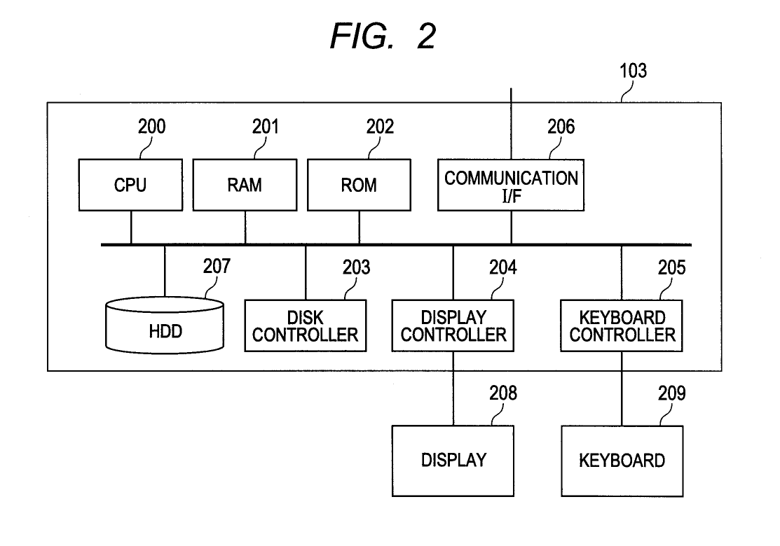

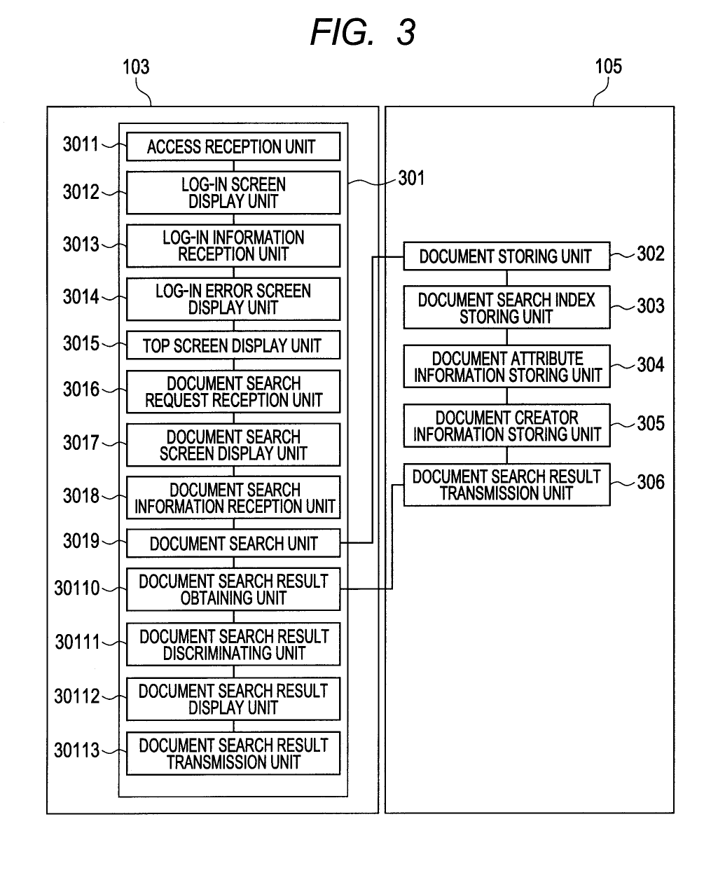

The first embodiment of the invention will be described with reference to FIGS. 1 to 3. FIGS. 1 and 2 are diagrams for describing component elements which are used as a prerequisite of the embodiment. FIGS. 3 to 10 are diagrams for describing units configured to embody the invention.

[System Construction]

FIG. 1 is a constructional diagram of a document search system according to the first embodiment of the invention. A client PC 101 on the document transmitting side is connected to an application server 103, an asynchronous server 104, and a database server 105 (document storing device) through a network 102.

A document searcher 106 logs-in a document management system in the application server 103 from the client PC 101 through the network 102 such as Internet or the like and searches for documents stored in the database server 105. If the number of relevant documents is larger than a predetermined threshold value set in the document management system, the document management system returns the number of relevant documents to the document searcher 106 and promotes a re-search (to search for the documents again). If it is smaller than the threshold value, the document management system transmits E-mail to a document creator 107 by using an smtp (Simple Mail Transfer Protocol) and obtains a permission of obtainment of the document.

In the embodiment, as for each of the client PCs 101 and 108, a plurality of client PCs may exist on the network. The document management system may be a dedicated application adapted to operate the document or a Web application which operates on a Web browser.

[Hardware Construction]

FIG. 2 illustrates a hardware constructional diagram of the application server 103 constructing the document search system according to the embodiment of the invention. It is assumed that the hardware constructional diagram illustrated in FIG. 2 corresponds to a hardware constructional diagram of a general information processing apparatus. The hardware construction of the general information processing apparatus can be applied to each server in the embodiment.

In FIG. 2, a CPU 200 executes a program such as operating system (hereinbelow, referred to as “OS”), application, or the like which has been stored in a program ROM in a ROM 202 or loaded from a hard disk drive (HDD) 207 into a RAM 201. Processes of each flowchart, which will be described hereinafter, can be realized by executing such a program. The RAM 201 functions as a main memory, a work area, or the like of the CPU 200. A keyboard controller 205 controls a key input from a keyboard 209. A display controller 204 controls a display of various kinds of displays 208. A disk controller 203 controls a data access in the HDD 207 which stores the received documents. A communication interface (I/F) 206 is connected to the network and executes a communication control process for controlling communication with other apparatuses connected to the network.

[Software Construction]

FIG. 3 is a software constructional diagram illustrating an example of the document search system according to the embodiment of the invention and illustrates a software construction in each of the application server 103 and the database server 105.

When an access request from the client PC 101 or 108 (hereinbelow, referred to as a client PC) to a document management system 301 is issued, an access reception unit 3011 receives the access request. When the access reception unit 3011 receives the access request from the client PC to the access reception unit 3011, a log-in screen display unit 3012 displays a log-in display screen to the client PC. A log-in information reception unit 3013 receives log-in information transmitted from the client PC and discriminates whether or not it is correct log-in information held in the document management system 301. If it is determined that the log-in information received by the log-in information reception unit 3013 in the document management system 301 is wrong, a log-in error screen display unit 3014 displays a log-in error display screen to the client PC. If it is determined that the log-in information received by the log-in information reception unit 3013 in the document management system 301 is correct, a Top screen display unit 3015 displays a Top display screen of the document management system 301. A document search request reception unit 3016 receives a document search request transmitted from the client PC. When the document search request reception unit 3016 receives the document search request transmitted from the client PC, a document search screen display unit 3017 displays a document search display screen to the client PC. A document search information reception unit 3018 receives document search information (condition which is used for document search) transmitted from the client PC on the document search display screen. A document search unit 3019 searches for the document from the documents stored in a document storing unit 302 of the database server 105 by using the document search information received by the document search information reception unit 3018. Further, the document search unit 3019 refers to a document search index storing unit 303 and a document attribute information storing unit 304 of the database server 105 from the document search information received by the document search information reception unit 3018.

Index information included in the document has been stored in the document search index storing unit 303. Attribute information such as document creation time/date, document change time/date, document creator, and the like has been stored in the document attribute information storing unit 304. Account information (a user ID and a password) of the document creator and an E-mail address of each document creator registered in the document management system 301 have been stored in a document creator information storing unit 305. As a result of that the document search unit 3019 has searched for the documents by using the document search information received by the document search information reception unit 3018, a document search result transmission unit 306 transmits the documents corresponding to the document search information to a document search result obtaining unit 30110. A document search result discriminating unit 30111 discriminates whether or not the number of relevant documents among the searched documents showing the document search result obtained by the document search result obtaining unit 30110 is larger than a threshold value set in the document search result discriminating unit 30111. If the document search result discriminating unit 30111 determines that the number of relevant documents obtained as a document search result is larger than the set threshold value, a document search result display unit 30112 displays the number of relevant documents and a message for promoting the re-search to the client PC. If the document search result discriminating unit 30111 determines that the number of relevant documents obtained as a document search result is smaller than the set threshold value, a document search result transmission unit 30113 transmits E-mail to the creator of the document included in the document search result.

The component elements illustrated in FIG. 3 are only the portions which are concerned with the invention. Naturally, component elements of the document search system are not limited only to them.

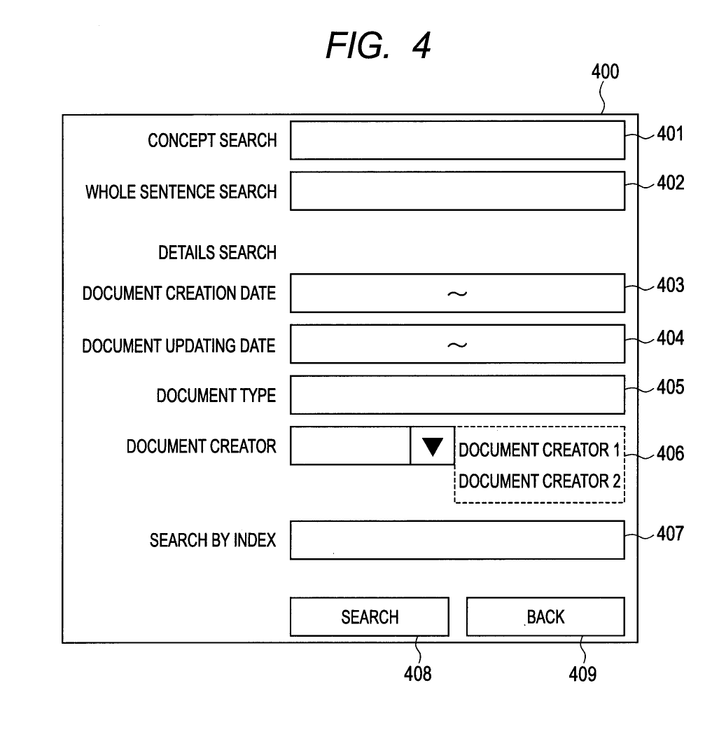

A process in each step of the document search system according to the embodiment of the invention will be specifically described hereinbelow with reference to FIGS. 4 to 9.

[Document Search Result Notifying Unit]

FIG. 4 is an example of a search display screen 400 which is used when the document searcher 106 searches for the document. A concept search information input column 401 is a column to input information which is used for concept search of the document. A whole sentence search information input column 402 is a column to input search information which is used to search for all words included in the document. Subsequently, in a details search, a document creation date information input column 403 is a column to input time/date or a period of time when the document has been formed. A document updating date information input column 404 is a column to input time/date or a period of time when the document has been updated. A document type information input column 405 is a column to input a file format (extension) of the document. The document creators are displayed in a pull-down format in a document creator selection column 406 and the document creator can be selected from them. An index information input column 407 is a column to input index information included in the document. When the document searcher 106 inputs at least one of the items in the information which is used for the foregoing search and clicks a search button 408, the input search information is transmitted from the client PC. When the document searcher clicks a back button 409, the document management system 301 displays the Top display screen.

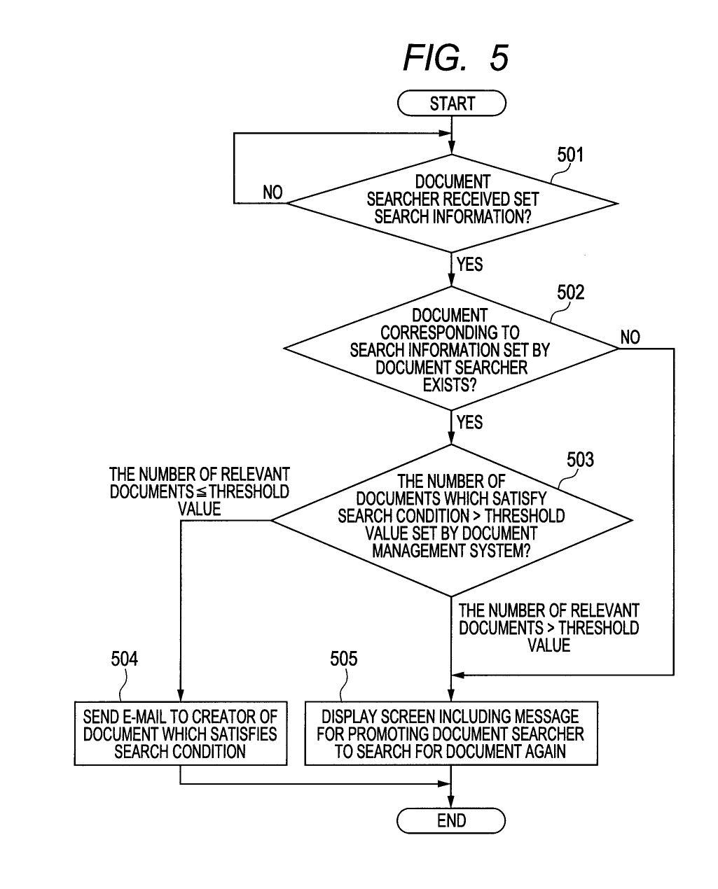

FIG. 5 is a flowchart illustrating a flow of a document search result notifying process in the embodiment. This process is executed by the CPU 200 illustrated in FIG. 2. In step 501, the document management system 301 discriminates whether or not the document searcher 106 has received the document search information set on the search display screen 400 of the document management system 301 displayed to the client PC 101. In step 502, the document management system 301 searches for the document corresponding to the received document search information. If the corresponding document does not exist in step 502, in step 505, a display screen including a message for promoting the document searcher 106 to search the document again is displayed. If the corresponding documents exist in step 502, in step 503, whether or not the number of relevant documents is larger than the threshold value set in the document management system 301 is discriminated. If it is determined in step 503 that the number of relevant documents is larger than the threshold value, the document management system 301 displays a display screen including the message for promoting the document searcher to search the document again to the client PC 101. If it is determined in step 503 that the number of relevant documents is equal to or less than the threshold value, in step 504, E-mail for inquiring about whether or not it is permitted that the document searcher obtains the relevant document is transmitted to the creator of the relevant document.

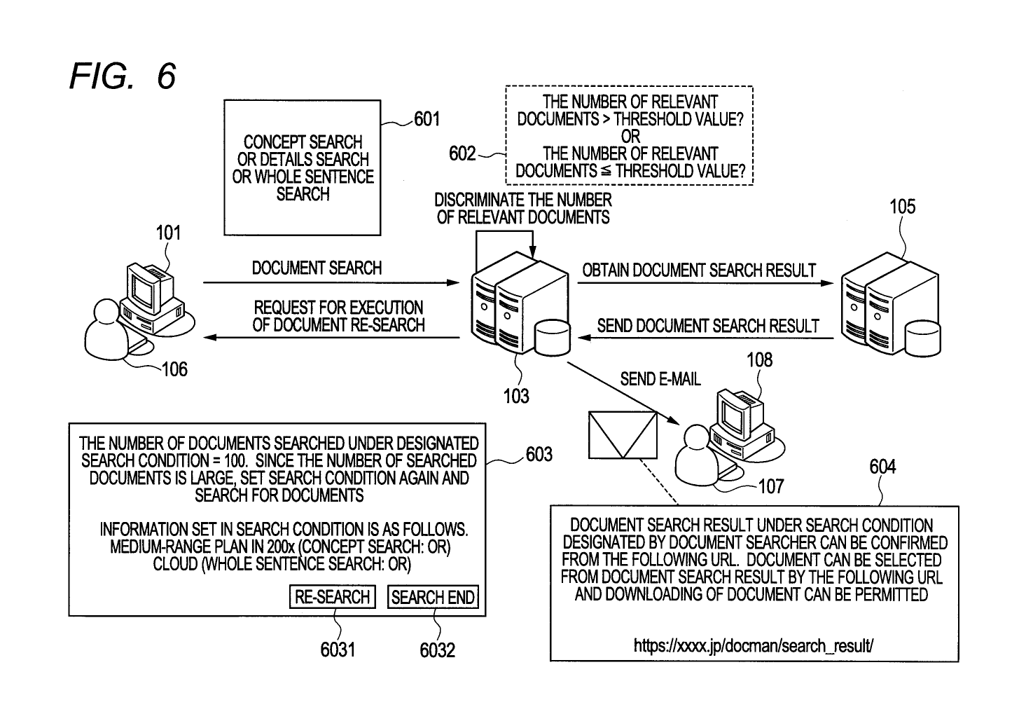

FIG. 6 is a conceptual diagram of the flowchart of FIG. 5. When the document searcher 106 allows the document management system 301 in the application server 103 to execute the document search from the client PC 101, a search mode is set from a document search mode 601. The document searcher 106 sets the search mode and the document search information from the document search mode 601 by the client PC 101 and transmit the document search information to the document management system 301. When the document search information transmitted from the client PC 101 is received, the document management system 301 issues a document search instruction to the database server 105. When the document search instruction is received from the document management system 301 and the document search process is completed, the database server 105 transmits a document search result to the document management system 301. The document management system 301 reads the number of relevant documents from the document search result received from the database server 105 and executes a discriminating process 602 of the number of relevant documents. If it is determined by the number-of-relevant-documents discriminating process 602 that the number of relevant documents is larger than the threshold value, the document management system 301 displays a document re-search request display screen 603 to the client PC 101, thereby requesting the document searcher 106 to search for the documents again. The document management system 301 also displays the number of relevant documents and the document search information set by the document searcher 106 onto the document re-search request display screen 603. By pressing a re-search button 6031 on the document re-search request display screen 603 by the client PC 101, the document searcher 106 can execute the document search again. When the document searcher 106 presses a search end button 6032 on the document re-search request display screen 603 by the client PC 101, the display screen is shifted to the Top display screen of the document management system 301. If it is determined by the number-of-relevant-documents discriminating process 602 that the number of relevant documents is equal to or less than the threshold value, the document management system 301 transmits E-mail 604 to the document creator 107 (client PC 108) of the relevant document.

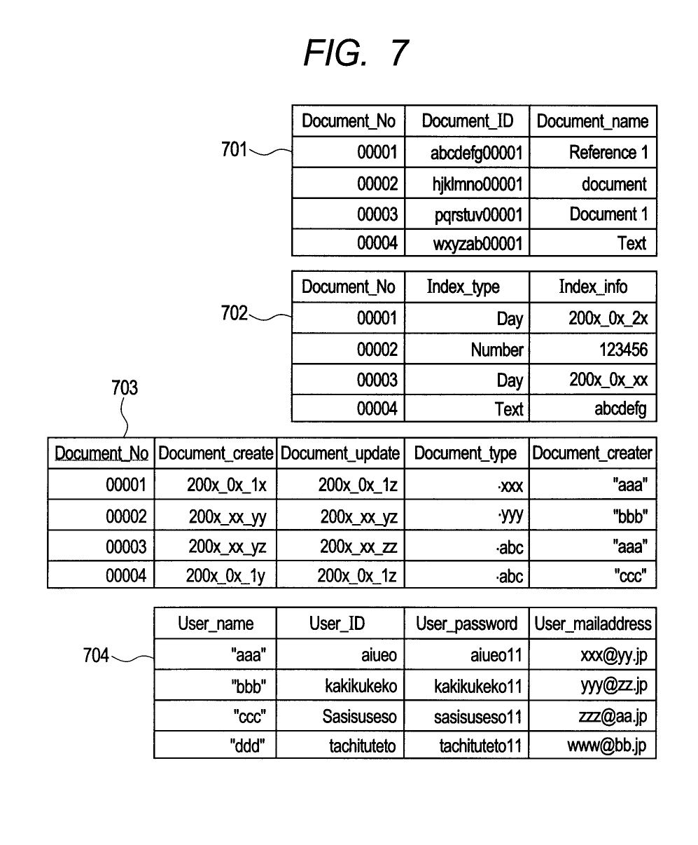

FIG. 7 is a diagram illustrating details of the document storing unit 302, document search index storing unit 303, document attribute information storing unit 304, and document creator information storing unit 305 stored in the database server 105. Storing order and number of the document, a document ID, and a document name have been stored in a document storage table 701. Index information included in the document has been stored in a document search index information storage table 702. That is, the storing order and number of the document, an index type, and information of the index have been stored in the table 702. Attribute information included in the document has been stored in a document attribute information storage table 703. That is, the storing order and number of the document, a date when the document is created, a date when the document is updated, an extension of the document, and information of the document creator have been stored in the table 703. A name of the document creator, the account information (the user ID and the password), and an E-mail address of each document creator have been stored in a document creator information storage table 704. As an operation of the process in the case where the document management system 301 searches for the document stored in the database server 105, first, the search information received from the client PC is analyzed. For example, if the received search information is the index information, the index type indicates a text, and “abcdefg” is designated as index information, the document management system 301 specifies the relevant document from the document search index information storage table 702. As a result of the specifying process, if the storing order and number of the relevant document are “00004” and the document corresponding to “00004” is searched for from the document storage table 701, the document name “text” is obtained as a search result. Further, “ccc” as a document creator of the document having the document name “text” and the E-mail address of the document creator are specified. For example, if the received search information is designated as “.abc” which is a document type of the attribute information, the document management system 301 specifies the relevant document from the document attribute information storage table 703. As a result of the specifying process, if the storing order and number of the relevant document are “00003” and “00004” and the documents corresponding to “00003” and “00004” are searched for from the document storage table 701, the document names “document 1” and “text” are obtained as a search result. “aaa” and “ccc” as document creators of the documents having the document names “document 1” and “text” and the E-mail address of each document creator are specified.

[Document Obtainment Accepting Unit Using Document Search Result Notifying Unit]

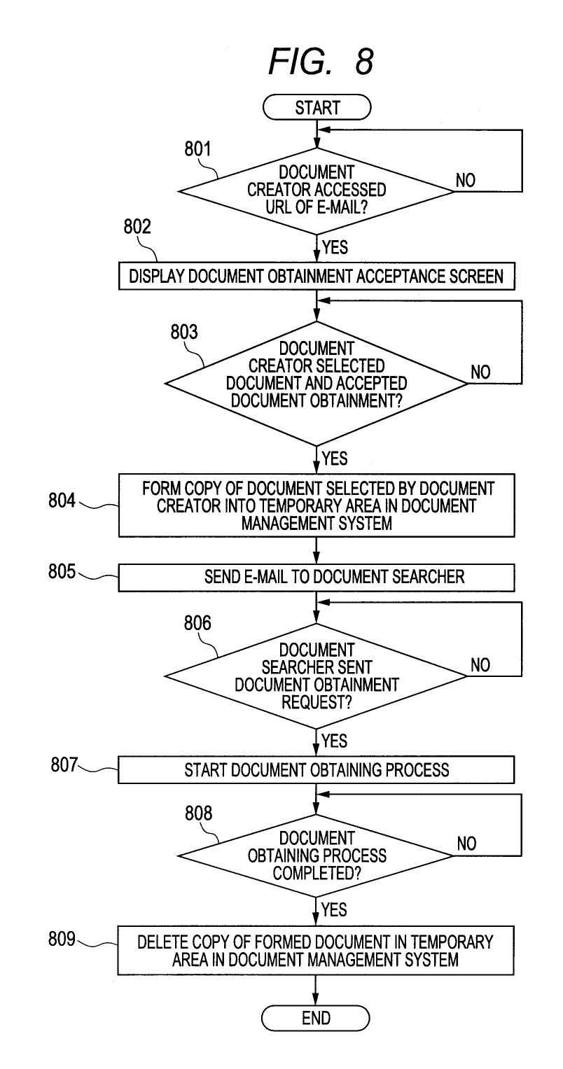

FIG. 8 is a flowchart for a document obtainment accepting unit using the document search result notifying unit. This process is executed by the CPU 200 illustrated in FIG. 2.

In step 801, the document management system 301 discriminates whether or not after the document searcher 106 searched for the document and the E-mail was transmitted from the document management system 301 to the document creator 107, the document creator 107 has accessed a URL included in the E-mail. If it is determined in step 801 that the document creator 107 has accessed the URL, the document management system 301 displays a document obtainment acceptance display screen in step 802. In step 803, the document management system 301 discriminates whether or not the document creator 107 has selected the proper document from the documents included in the search result and accepted the document obtainment. If it is determined in step 803 that the document creator 107 has accepted the document obtainment, in step 804, the document management system 301 forms a copy of the obtainment-accepted document selected by the document creator 107 into a temporary area in the document management system 301. In step 805, the document management system 301 transmits E-mail, which will be described hereinafter, to the document searcher 106. In step 806, the document management system 301 discriminates whether or not the document searcher 106 has logged-in the document management system 301 and transmitted a document obtaining request thereto. When the document obtaining request from the document searcher 106 is received in step 806, the document management system 301 starts a document obtaining process in step 807. In step 808, the document management system 301 discriminates whether or not the document obtaining process started by the document searcher 106 is completed. If it is determined in step 808 that the document obtaining process is completed, in step 809, the document management system 301 deletes the document copy formed in step 804.

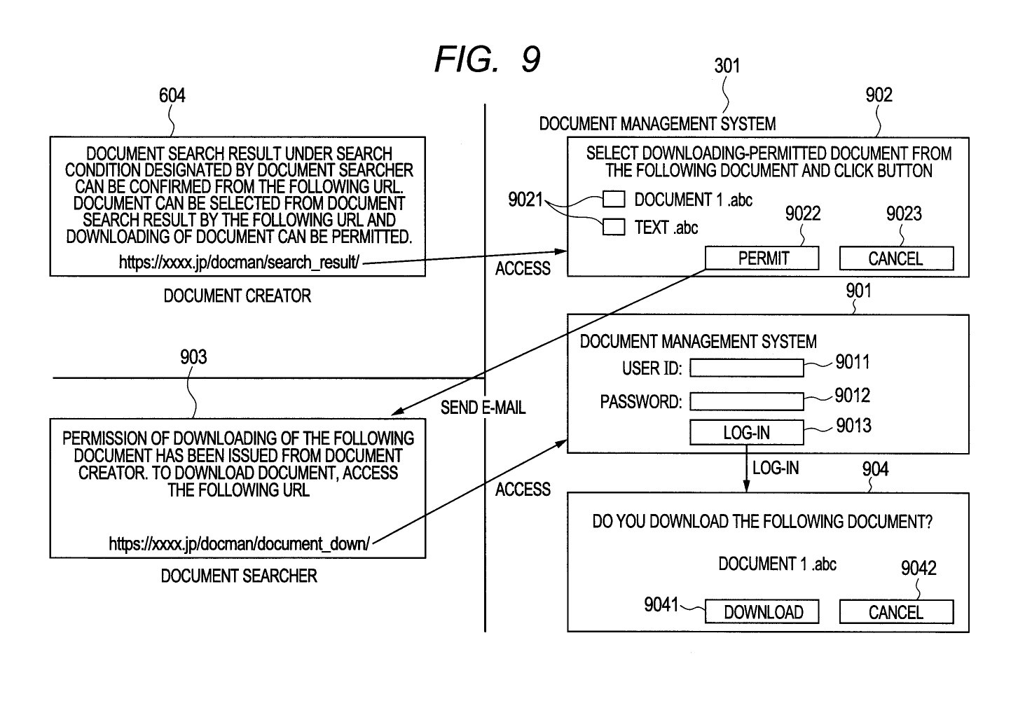

FIG. 9 illustrates an example of a UI of the document obtainment accepting unit using the document search result notifying unit and the E-mail which is transmitted to the document searcher 106. When the document creator 107 accesses a URL included in a body of the E-mail 604 received by the document creator 107, the document management system 301 displays a log-in display screen 901. When the document creator 107 inputs his own user account to a user ID input column 9011 and a password input column 9012, clicks a log-in button 9013, and logs-in the document management system 301, the document management system 301 displays a document obtainment acceptance display screen 902. On the document obtainment acceptance display screen 902, in order to permit the document obtainment of the document searcher 106, the document creator 107 checks a check box 9021 of the document whose obtainment is permitted and clicks a permit button 9022. If it is determined that the document creator 107 has clicked the permit button 9022, the document management system 301 transmits E-mail 903 to the document searcher 106. When the document creator 107 clicks a cancel button 9023 on the document obtainment acceptance display screen 902, the document management system 301 displays the Top display screen. When the document searcher 106 accesses a URL included in the E-mail 903, the document management system 301 displays the log-in display screen 901. When the document searcher 106 inputs his own user account to the user ID input column 9011 and the password input column 9012 on the log-in display screen 901, clicks the log-in button 9013, and logs-in the document management system 301, the document management system 301 displays a document obtainment display screen 904. When the document searcher 106 clicks a download button 9041 on the document obtainment display screen 904, the document management system 301 executes a document obtaining process. After completion of the document obtaining process, the document management system 301 displays the Top display screen. When the document searcher 106 clicks a cancel button 9042 on the document obtainment display screen 904, the document management system 301 displays the Top display screen.

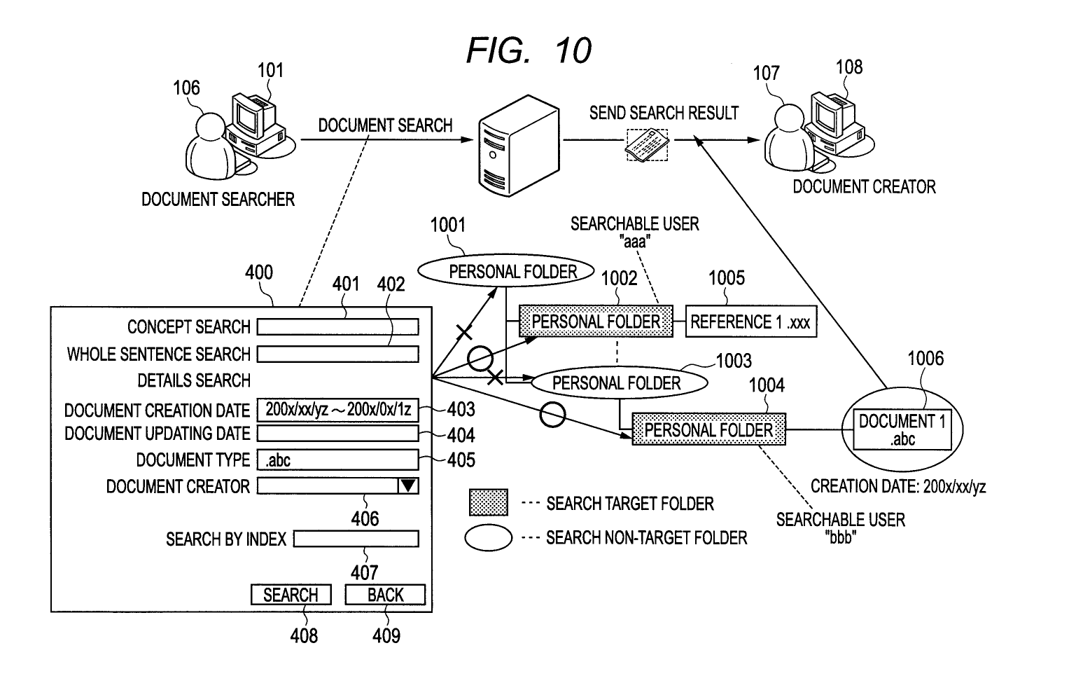

FIG. 10 illustrates an example of a process in which the document creator 107 sets a folder serving as a search target. For example, it is assumed that there are personal folders 1001 to 1004 owned by the document creator 107, a document 1005 was stored in the personal folder 1002, and a document 1006 was stored in the personal folder 1004. It is also assumed that the document creator 107 set the personal folders 1002 and 1004 as search target folders, the user who can search for the personal folder 1002 was set to “aaa”, and the user who can search for the personal folder 1004 was set to “bbb”. It is also assumed that the document searcher 106 is the user “bbb”, the document search information (the document creation date 403 and the document type 405 in FIG. 10) was designated on the search display screen 400, the search button 408 was clicked, and the document search was executed.

The document management system 301 searches for the personal folders 1002 and 1004 of the document creator 107 and specifies the document corresponding to the document search information set by the document searcher 106. In FIG. 10, since the document search information set by the document searcher 106 is “200x/xx/yz˜200x/0x/1z” (document creation date) and “.abc” (document type), the relevant document is the document 1006 (document 1 .abc) stored in the personal folder 1004. As a result of the document search, if the obtained number of searched documents is equal to or less than the threshold value set in the document management system 301, the document 1006 is included in the document search result.

### Second Embodiment

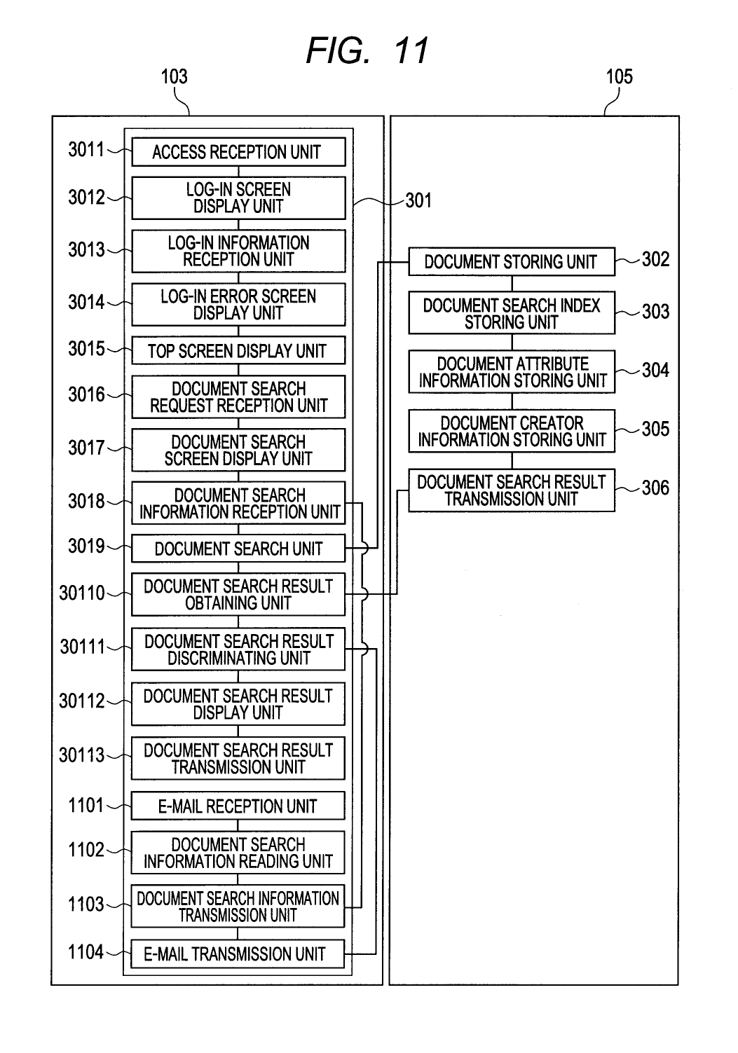

The second embodiment of the invention will be described with reference to FIGS. 11 to 17B. In the second embodiment, the document searcher 106 transmits the document search information to the document management system 301 by using an E-mail client. The document management system 301 searches for the document corresponding to the received document search information and discriminates whether or not the number of searched documents obtained as a search result is larger than the threshold value set in the document management system 301. If it is determined that the number of searched documents obtained as a search result is larger than the threshold value set in the document management system 301, the document management system 301 transmits the E-mail including a message for requesting the re-search of the document to the document searcher 106. If it is determined that the number of searched documents is equal to or less than the threshold value, the document management system 301 transmits the E-mail to the creator of the document corresponding to the search result. Since a system construction and a hardware construction are similar to those in the first embodiment, they are omitted here.

[Software Construction]

FIG. 11 illustrates a software construction. FIG. 11 differs from FIG. 3 with respect to a point that an E-mail reception unit 1101, a document search information reading unit 1102, a document search information transmission unit 1103, and an E-mail transmission unit 1104 are added to the document management system 301.

The E-mail reception unit 1101 receives the E-mail in which the document searcher designated the document search information to the body of the E-mail by using the E-mail client and has transmitted by using an smtp (Simple Mail Transfer Protocol). The document search information reading unit 1102 reads the document search information on a text unit basis from the E-mail received by the E-mail reception unit 1101 and transmits the read document search information to the document search information transmission unit 1103. The document search information transmission unit 1103 transmits the document search information transmitted from the document search information reading unit 1102 to the document search information reception unit 3018. Since processes which are executed by the units within a range from the document search information reception unit 3018 to the document search result discriminating unit 30111 are similar to those in the first embodiment, their description is omitted here. If it is determined that the number of searched documents obtained as a search result is larger than the threshold value set in the document management system 301, the document search result discriminating unit 30111 issues an instruction to the E-mail transmission unit 1104. The E-mail transmission unit 1104 transmits the E-mail including the message for requesting the re-search of the document to the document searcher 106 by using the smtp.

[Document Search Result Notifying Unit Using E-Mail]

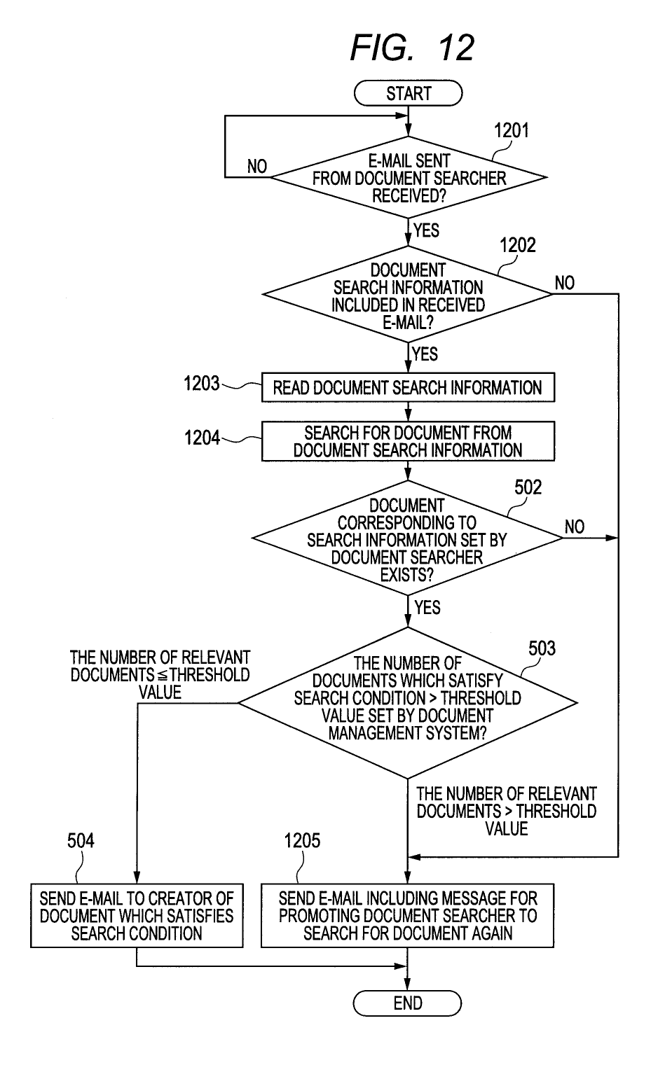

FIG. 12 is a flowchart of the second embodiment. This process is executed by the CPU 200 illustrated in FIG. 2.

In step 1201, the document management system 301 discriminates whether or not the E-mail transmitted from the document searcher 106 is received. If it is decided in step 1201 that the document management system 301 has received the E-mail, in step 1202, the document management system 301 discriminates whether or not the document search information is included in the E-mail. If it is decided in step 1202 that the document search information is not included in the E-mail, in step 1205, the document management system 301 transmits the E-mail including the message for requesting the re-search of the document to the document searcher 106. If it is decided in step 1202 that the document search information is included in the E-mail, in step 1203, the document management system 301 reads the document search information from the E-mail. The document management system 301 searches for the document based on the document search information read in step 1203. In step 502, the document management system 301 determines whether any document corresponding to the document search information exists. If the relevant document does not exist in step 502, the document management system 301 transmits the E-mail including the message for requesting the re-search of the document to the document searcher 106 in step 1205. If the relevant document exists in step 502, the document management system 301 discriminates whether or not the number of relevant documents is larger than the threshold value set in the document management system 301 in step 503. If it is determined in step 503 that the number of relevant documents is larger than the threshold value, the document management system 301 transmits the E-mail including the message for requesting the re-search of the document to the document searcher 106 in step 1205. If it is determined in step 503 that the number of relevant documents is equal to or less than the threshold value, the document management system 301 transmits E-mail, which will be described hereinafter, to the creator of the relevant document in step 504.

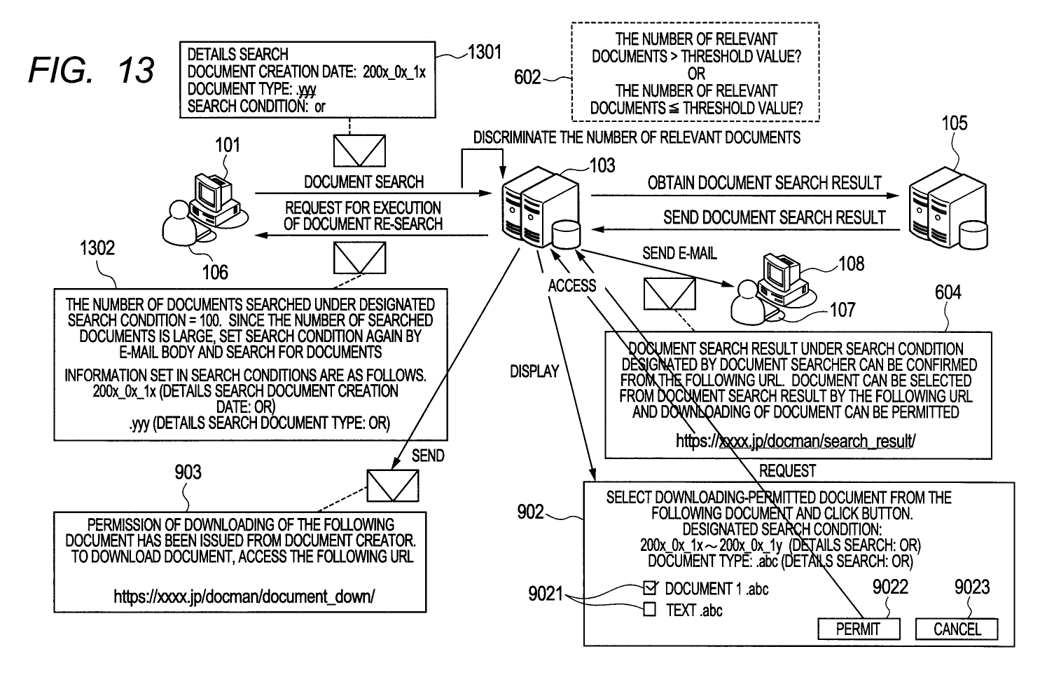

FIG. 13 is a conceptual diagram of the flowchart of FIG. 12. The document searcher 106 sets the document search information to search for the document by E-mail 1301. In the E-mail 1301, a document creation date “200x_{—}0x_{—}1x”, a document type “.yyy”, and a search condition “or” are designated as details search information. The document corresponding to either the document creation date or the document type is searched for. The document management system 301 receives the E-mail transmitted from the document searcher 106 and reads the document search information from the body of the E-mail. The document management system 301 searches for the document stored in the database server 105 from the read document search information. The database server 105 transmits the document corresponding to the document search information to the document management system 301. The document management system 301 reads the number of relevant documents from the document search result received from the database server 105 and executes the number-of-relevant-documents discriminating process 602. If it is decided by the number-of-relevant-documents discriminating process 602 that the number of relevant documents is larger than the threshold value, the document management system 301 transmits E-mail 1302 including a request for execution of a document re-search to the document searcher 106. By the E-mail 1302, the document management system 301 displays the document search result number and the document search information which was set by the document searcher 106. If it is decided by the number-of-relevant-documents discriminating process 602 that the number of relevant documents is equal to or less than the threshold value, the document management system 301 transmits the E-mail 604 to the document creator 107 (client PC 108) of the relevant document. The document creator 107 accesses the URL in the E-mail 604, selects the document whose obtainment is permitted on the document obtainment acceptance display screen 902 of the document management system 301, and clicks the permit button 9022. The document management system 301 transmits the E-mail 903 to the document searcher 106.

[Document Search Information Extraction Unit Written in E-Mail Body]

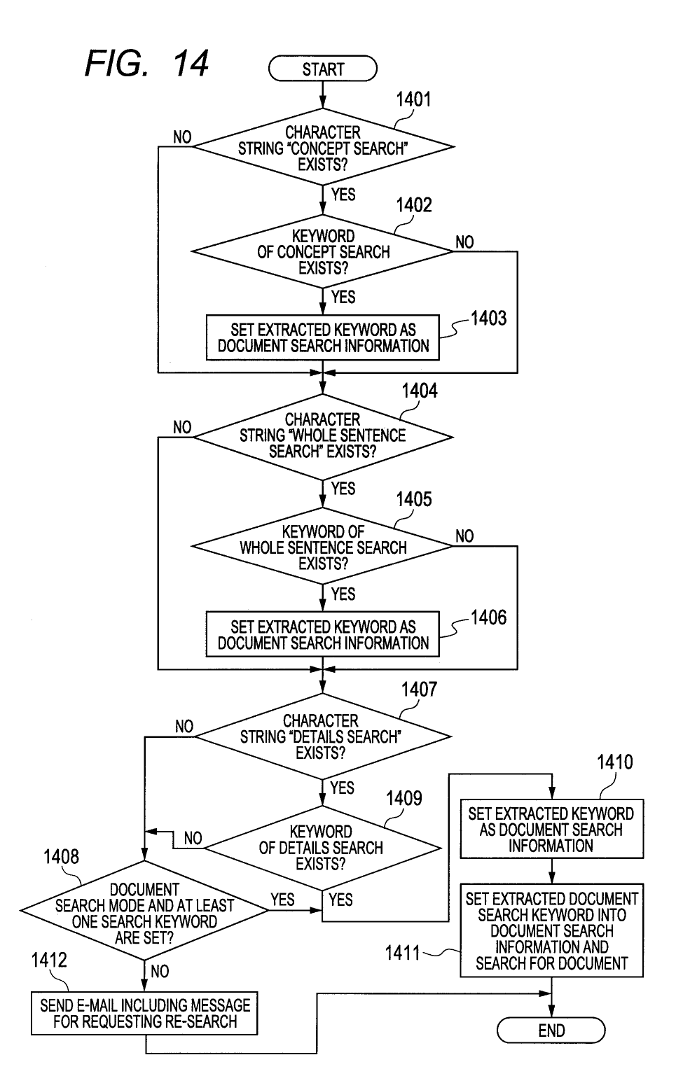

FIG. 14 is a flowchart for a document search information extracting process in the second embodiment. This process is executed by the CPU 200 illustrated in FIG. 2.

In step 1401, the document management system 301 discriminates whether or not a character string “concept search” is included in the body of the E-mail 1301 in FIG. 13. If it is determined in step 1401 that the character string “concept search” is included in the body of the E-mail 1301, in step 1402, the document management system 301 discriminates whether or not a keyword of the concept search is included in the body of the E-mail 1301. If it is determined in step 1401 that the character string “concept search” is not included in the body of the E-mail 1301, in step 1404, the document management system 301 discriminates whether or not a character string “whole sentence search” is included. If it is determined in step 1402 that the keyword of the concept search is included in the body of the E-mail 1301, in step 1403, the document management system 301 sets a document search mode (concept search) and the keyword of the concept search as document search information. If it is determined in step 1402 that the keyword of the concept search is not included in the body of the E-mail 1301, in step 1404, the document management system 301 discriminates whether or not the character string “whole sentence search” is included in the body of the E-mail 1301. If it is determined in step 1404 that the character string “whole sentence search” is included in the body of the E-mail 1301, in step 1405, the document management system 301 discriminates whether or not a keyword of the whole sentence search is included in the body of the E-mail 1301. If it is determined in step 1404 that the character string “whole sentence search” is not included in the body of the E-mail 1301, in step 1407, the document management system 301 discriminates whether or not a character string “details search” is included in the body of the E-mail 1301. If it is determined in step 1405 that the keyword of the whole sentence search is included in the body of the E-mail 1301, in step 1406, the document management system 301 sets a document search mode (whole sentence search) and the keyword of the whole sentence search as document search information. If it is determined in step 1405 that the keyword of the whole sentence search is not included in the body of the E-mail 1301, in step 1407, the document management system 301 discriminates whether or not the character string “details search” is included in the body of the E-mail 1301. If it is determined in step 1407 that the character string “details search” is included in the body of the E-mail 1301, in step 1409, the document management system 301 discriminates whether or not a keyword of the details search is included in the body of the E-mail 1301. If it is determined in step 1407 that the character string “details search” is not included in the body of the E-mail 1301, in step 1408, the document management system 301 discriminates whether or not a document search mode and at least one search keyword are set. If it is determined in step 1408 that neither a document search mode nor a search keyword is set, in step 1412, the document management system 301 transmits the E-mail including the message for requesting the re-search of the document to the document searcher 106. If it is determined in step 1408 that a document search mode and at least one search keyword are set, in step 1410, the document management system 301 sets the document search mode and the search keyword as document search information. If it is determined in step 1409 that the keyword of the details search is included, in step 1410, the document management system 301 sets the document search mode (details search) and the keyword of the details search as document search information. If it is determined in step 1409 that the keyword of the details search is not included, in step 1408, the document management system 301 discriminates whether or not a document search mode other than the details search and at least one search keyword are set. When the document search mode (details search) and the keyword of the details search are set as document search information in step 1410, the document management system 301 searches for the document based on the set document search information in step 1411.

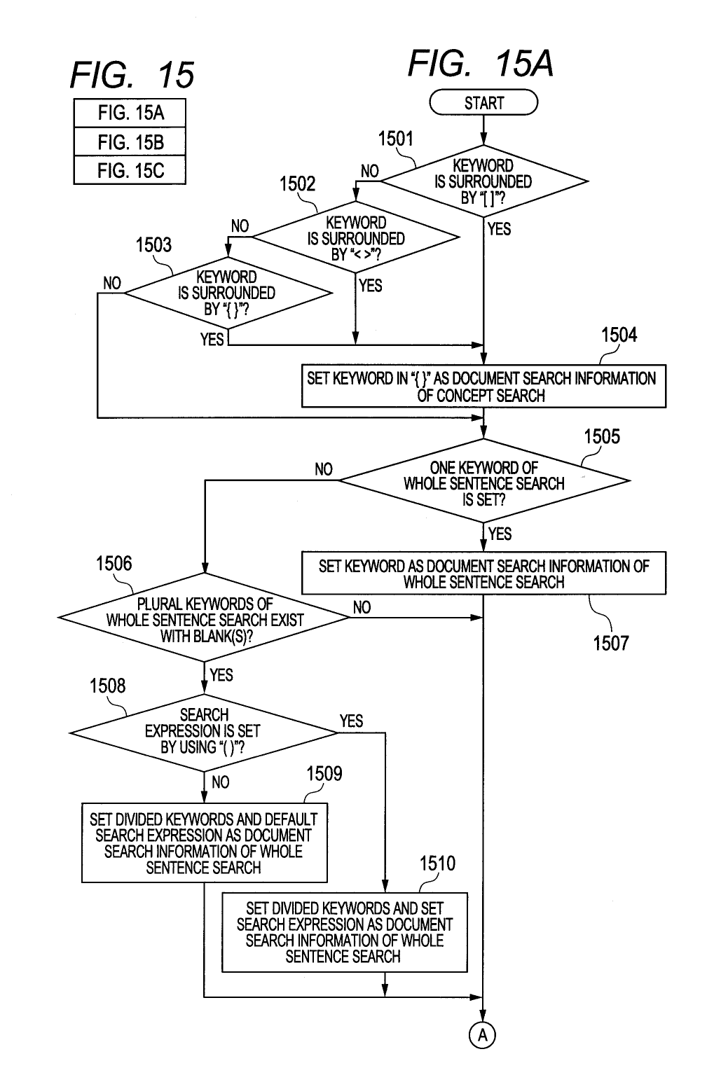

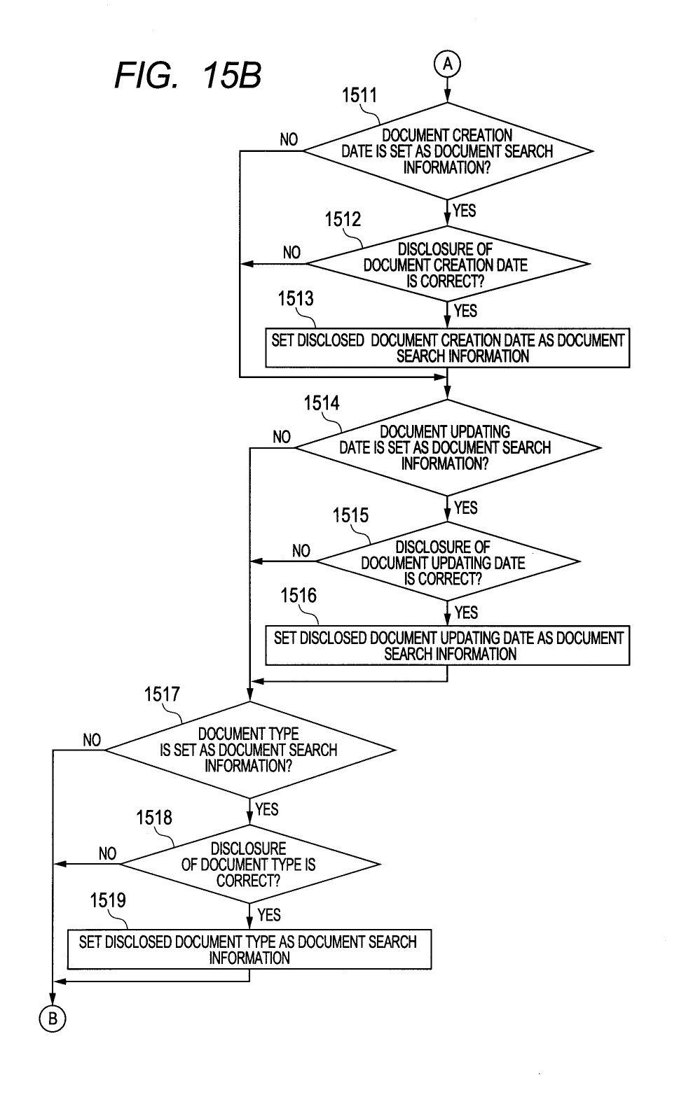

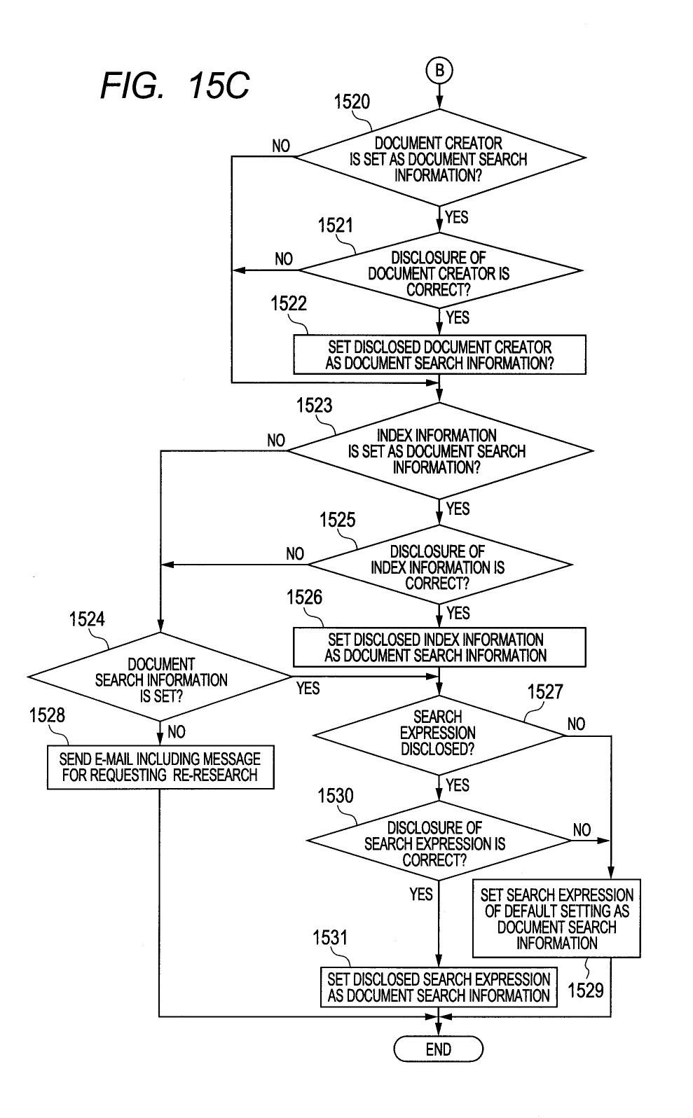

FIGS. 15A to 15C are a flowchart illustrating in detail steps 1403, 1406, and 1410 in FIG. 14.

In step 1501, the document management system 301 discriminates whether or not the keyword of the concept search is surrounded by “[ ]”. If it is determined in step 1501 that the keyword of the concept search is surrounded by “[ ]”, in step 1504, the document management system 301 sets the keyword of the concept search surrounded by “[ ]” as document search information of the concept search. If it is determined in step 1501 that the keyword of the concept search is not surrounded by “[ ]”, in step 1502, the document management system 301 discriminates whether or not the keyword of the concept search is surrounded by “< >”. If it is determined in step 1502 that the keyword of the concept search is surrounded by “< >”, in step 1504, the document management system 301 sets the keyword of the concept search surrounded by “< >” as document search information of the concept search. If it is determined in step 1502 that the keyword of the concept search is not surrounded by “< >”, in step 1503, the document management system 301 discriminates whether or not the keyword of the concept search is surrounded by “{ }”. If it is determined in step 1503 that the keyword of the concept search is surrounded by “{ }”, in step 1504, the document management system 301 sets the keyword of the concept search surrounded by “{ }” as document search information of the concept search. If it is determined in step 1503 that the keyword of the concept search is not surrounded by “{ }”, in step 1505, the document management system 301 discriminates whether or not one keyword of the whole sentence search is set. The parentheses which surround the keyword of the concept search are not limited to “[ ]”, “< >”, and “{ }” but such a discrimination can be also made by the document management system 301.

If it is determined in step 1505 that one keyword of the whole sentence search is set, in step 1507, the document management system 301 sets the keyword of the whole sentence search as document search information. If it is determined in step 1505 that the number of set keywords of the whole sentence search is not 1 (one), in step 1506, the document management system 301 discriminates whether or not a plurality of keywords of the whole sentence search exist with blank(s). If it is determined in step 1506 that a plurality of keywords of the whole sentence search exist with blank(s), in step 1508, the document management system 301 discriminates whether or not a search condition of the whole sentence search is set by using “( )”. If it is determined in step 1506 that a plurality of keywords of the whole sentence search do not exist with blank(s), in step 1511, the document management system 301 discriminates whether or not the document creation date is set as document search information of the details search. If it is determined in step 1508 that the search condition of the whole sentence search is set by using “( )”, in step 1510, the document management system 301 sets a plurality of keywords of the whole sentence search obtained as a result of dividing a blank portion and the search condition as document search information of the whole sentence search. If it is determined in step 1508 that the search condition of the whole sentence search is not set by using “( )”, in step 1509, a plurality of keywords of the whole sentence search obtained as a result of dividing the blank portion and the search condition which is set as a default are set as document search information of the whole sentence search.

If it is determined in step 1511 that the document creation date is set as document search information of the details search, in step 1512, the document management system 301 discriminates whether or not the disclosure of the document creation date is correct. If it is determined in step 1511 that the document creation date is not set as document search information of the details search, in step 1514, it is discriminated whether or not the document updating date is set as document search information of the details search. If it is determined in step 1512 that the disclosed document creation date is as disclosed (for example, 200x/xx/xx, 200x/xx/xx˜200x/xy/xy) set in the document management system 301, in step 1513, the document management system 301 sets the disclosed document creation date as document search information. If it is determined in step 1512 that the disclosed document creation date is not the disclosure set in the document management system 301, in step 1514, whether or not the document updating date is set as document search information of the details search is discriminated. If it is determined in step 1514 that the document updating date is set as document search information, in step 1515, the document management system 301 discriminates whether or not the disclosure of the document updating date is correct. If it is determined in step 1514 that the document updating date is not set as document search information, in step 1517, whether or not the document type is set as document search information of the details search is discriminated. If it is determined in step 1515 that the disclosed document updating date is as disclosed (for example, 200x/xx/xx, 200x/xx/xx˜200x/xy/xy) set in the document management system 301, in step 1516, the document management system 301 sets the disclosed document updating date as document search information. If it is determined in step 1515 that the disclosed document updating date is not the disclosure set in the document management system 301, in step 1517, whether or not the document type is set as document search information of the details search is discriminated. If it is determined in step 1517 that the document type is set as document search information, in step 1518, the document management system 301 discriminates whether or not the disclosure of the document type is correct. If it is determined in step 1517 that the document type is not set as document search information, in step 1520, it is discriminated whether or not the document creator is set as document search information of the details search.

If it is determined in step 1518 that the disclosed document type is as disclosed (for example, .abc, .abc .def) set in the document management system 301, in step 1519, the document management system 301 sets the disclosed document type as document search information. If it is determined in step 1518 that the disclosed document type is not the disclosure set in the document management system 301, in step 1520, whether or not the document creator is set as document search information of the details search is discriminated. If it is determined in step 1520 that the document creator is set as document search information, in step 1521, the document management system 301 discriminates whether or not the disclosure of the document creator is correct. If it is determined in step 1520 that the document creator is not set as document search information, in step 1523, it is discriminated whether or not the index information is set as document search information of the details search. If it is determined in step 1521 that the disclosed document creator is as disclosed (for example, “aaa”, “bbb”) set in the document management system 301, in step 1522, the document management system 301 sets the disclosed document creator as document search information. If it is determined in step 1521 that the disclosed document type is not the disclosure set in the document management system 301, in step 1523, whether or not the index information is set as document search information of the details search is discriminated.

If it is determined in step 1523 that the index information is set as document search information, in step 1525, the document management system 301 discriminates whether or not the disclosure of the index information is correct. If it is determined in step 1523 that the index information is not set as document search information, in step 1524, it is discriminated whether or not the document search information is set. If it is determined in step 1525 that the disclosed index information is as disclosed set in the document management system 301, in step 1526, the document management system 301 sets the disclosed index information as document search information. If it is determined in step 1525 that the disclosed index information is not the disclosure set in the document management system 301, in step 1524, it is discriminated whether or not the document search information is set. If it is determined in step 1524 that no document search information is set, the document management system 301 transmits the E-mail including the message for requesting the re-search in step 51528. If it is determined in step 1524 that at least one document search information is set, in step 1527, it is discriminated whether or not the search condition is disclosed. If it is determined in step 1527 that the search condition is disclosed, in step 1530, the document management system 301 discriminates whether or not the disclosure of the search condition is correct. If it is determined in step 1527 that the search condition is not disclosed, in step 1529, the search condition which is set as a default is set as document search information in the document management system 301. If it is determined in step 1530 that the disclosure of the search condition is correct, in step 1531, the document management system 301 sets the disclosed search condition as document search information. If it is determined in step 1530 that the disclosure of the search condition is not correct, in step 1529, the search condition which is set as a default is set as document search information in the document management system 301.

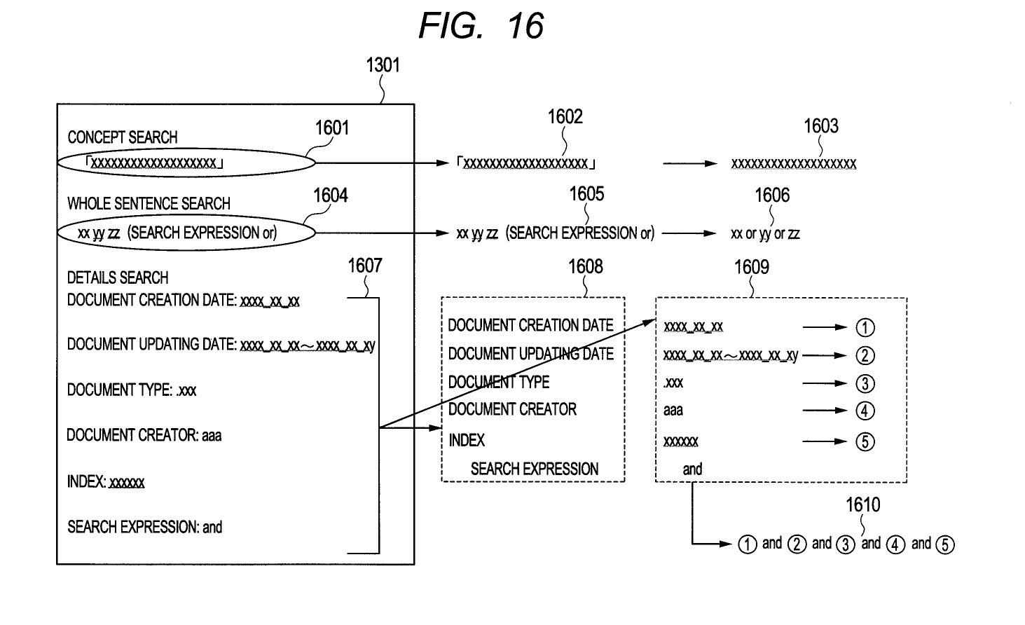

FIG. 16 is an example in which the document management system 301 extracts a character string written in the body of the E-mail 1301 and reads out document search information. The document management system 301 extracts a character string 1601 written in the E-mail 1301 and serving as a keyword of the concept search and reads a character string 1602. The document management system 301 reads a character string 1603 excluding “[ ]” included in the character string 1602 as a keyword of the concept search and sets the concept search and the keyword (character string 1603) as document search information. The document management system 301 extracts a character string 1604 written in the E-mail 1301 and serving as a keyword of the whole sentence search and reads a character string 1605. The document management system 301 reads “( )” showing a blank and a search condition in the character string 1605 and reads the keyword of the whole sentence search and the search condition of the keyword. The document management system 301 converts the character string 1605 into a character string 1606 including the keyword and the search condition and sets as document search information. The document management system 301 extracts a character string group 1607 written as details search information in the E-mail 1301. When the character strings existing on the right and left sides of “:” of the character string group 1607 are extracted, the document management system 301 forms a character string group 1608 including the attribute information of the details search and a character string group 1609 including the keyword corresponding to the attribute information of the details search. Further, the document management system 301 converts the character string group 1609 into a character string 1610 including the keyword and the search condition and sets as document search information.

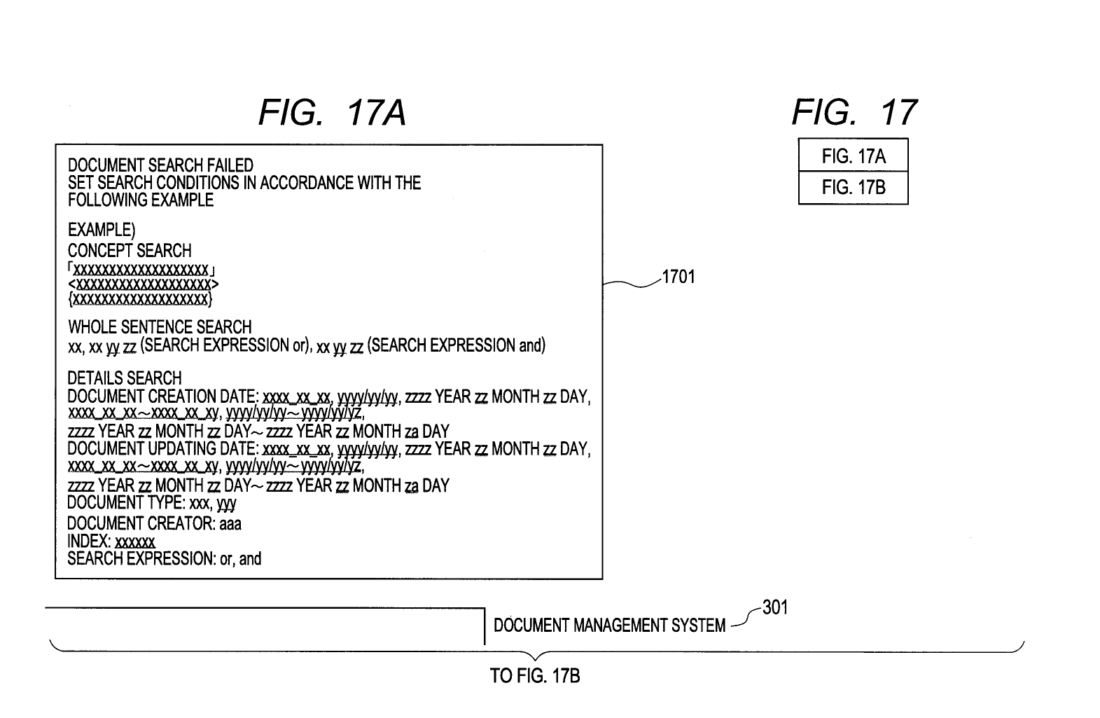

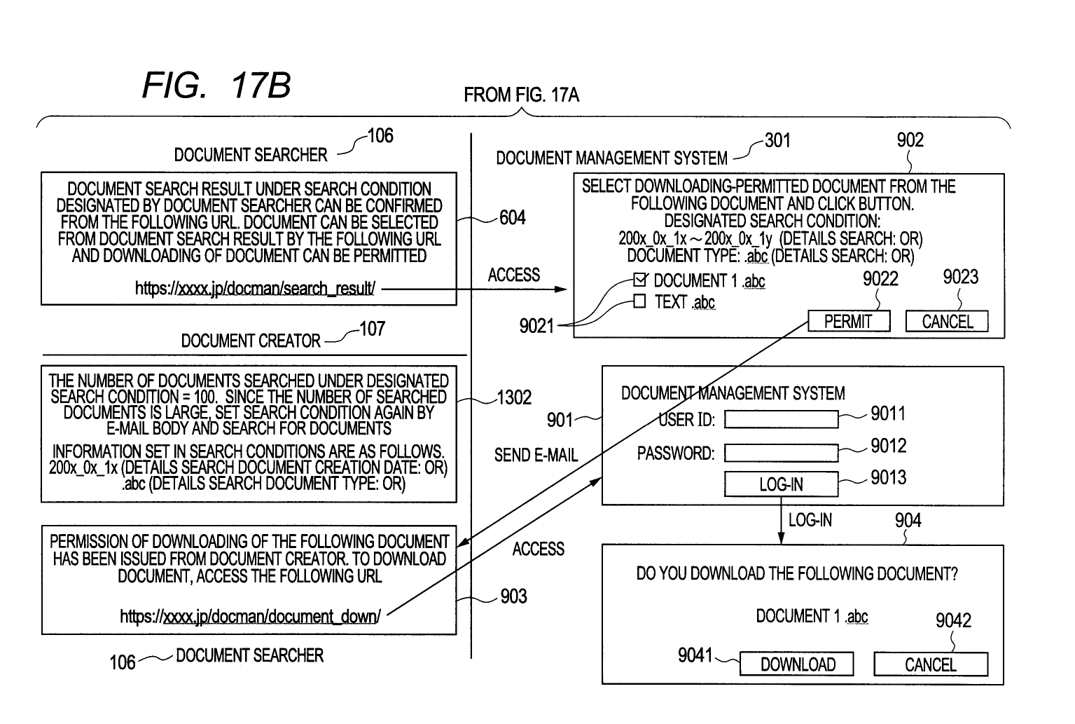

FIGS. 17A and 17B are an example of a body of E-mail which is transmitted to the document searcher 106 in step 1412 in FIG. 14. The document searcher 106 writes the document search information to the body of the E-mail and transmits the E-mail to the document management system 301. The document management system 301 discriminates whether or not the disclosure of the document search information included in the body of the received E-mail conforms with the disclosure set in the document management system 301. If it is determined that the disclosure of the document search information included in the body of the received E-mail is wrong, the document management system 301 transmits E-mail 1701 to the document searcher 106. If it is determined that the disclosure of the document search information included in the body of the received E-mail is correct, the document search information is extracted and the document corresponding to the extracted document search information is searched for. As a result of the document search, if the number of relevant documents is larger than the threshold value set in the document management system 301, the document management system 301 transmits the E-mail 1302 to the document searcher 106. If the number of relevant documents is equal to or less than the threshold value, the E-mail 604 is transmitted to the document creator 107. When the document creator 107 accesses a URL written in the E-mail 604, selects the document whose obtainment is permitted on the document obtainment acceptance display screen 902, and clicks the permit button 9022, the document management system 301 transmits the E-mail 903 to the document searcher 106. When the document searcher 106 accesses a URL written in the E-mail 903 and logs-in the document management system 301, the document management system 301 displays the document obtainment display screen 904. When the document searcher 106 clicks the download button 9041 on the document obtainment display screen 904, the document management system 301 starts the document obtaining process.

### Other Embodiments

The invention is also realized by executing the following processes. That is, software (program) for realizing the functions of the embodiments mentioned above is supplied to a system or an apparatus through a network or various kinds of storage media, a computer (or a CPU, an MPU, or the like) of the system or apparatus reads out the program and executes processes corresponding to the program.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-070026, filed Mar. 25, 2010, which is hereby incorporated by reference herein in its entirety.

What is claimed is:

1. A document management system for communicating with a document storing device in which a plurality of documents are stored, comprising:
a reception unit configured to receive document search information designated by a document searcher;
a search unit configured to search the document storing device for one or more of the plurality of documents corresponding to the document search information received by the reception unit;
a first transmission unit configured to transmit a message requesting a permission for the document searcher to obtain the one or more documents searched for by the search unit to a creator of the document; and
a second transmission unit configured to transmit a message for obtaining the one or more documents to the document searcher if the creator of the document gives the permission.

2. A system according to claim 1, further comprising:
a discriminating unit configured to discriminate whether or not the number of documents searched for by the search unit is larger than a predetermined threshold value; and
a third transmission unit configured to transmit a message promoting a re-search to the document searcher if the discriminating unit discriminates that the number of searched documents is larger than the threshold value,
wherein the discriminating unit discriminates that the number of searched documents is equal to or less than the threshold value, the first transmission unit transmits the message requesting the permission to the creator of the document.

3. A system according to claim 1, wherein the document management system is executed by an application server, and wherein the document storing device is a database server.

4. A system according to claim 2, wherein the third transmission unit transmits the message promoting the re-search together with the number of searched documents and the document search information used for the search.

5. A system according to claim 1, wherein the first transmission unit transmits the message requesting the permission of the obtainment together with URL information, and wherein an acceptance display screen specified by the URL information includes a list of the searched documents and a button for allowing the document searcher to select whether or not the obtainment is permitted with respect to each of the documents displayed on the list.

6. A system according to claim 5, wherein when the document creator gives the permission, the document management system forms a copy of each of the one or more documents and transmits the copy to the document searcher, and when the transmission is completed, the document management system deletes the copy.

7. A system according to claim 1, wherein the search unit searches the document storing device for at least one of the plurality of documents set as a target of the search by the document creator.

8. A system according to claim 1, wherein the reception unit receives E-mail including the document search information, and the first transmission unit transmits E-mail including the message requesting the permission to the document creator.

9. A document management method of managing a plurality of documents stored in a document storing device, the method comprising:
receiving document search information designated by a document searcher;
searching the document storing device for one or more of the plurality of documents corresponding to the received document search information;
transmitting a message requesting a permission for the document searcher to obtain the searched one or more documents to a creator of the document; and
transmitting a message for obtaining the one or more documents to the document searcher if the creator of the document gives the permission.

10. A non-transitory computer-readable storage medium storing a computer program for causing a computer to execute the document management method according to claim 9.
